(19) United States
(12) Patent Application Publication
(10) Pub. No.: US 2010/0332640 A1
(43) Pub. Date: Dec. 30, 2010

(54) METHOD AND APPARATUS FOR UNIFIED VIEW

(76) Inventors: Dennis Sidney GOODROW, Santa Rosa, CA (US); Peter Benjamin LOER, Oakland, CA (US); Jeremy Scott SPIEGEL, San Francisco, CA (US); Gregory Mitchell TOTO, Piedmont, CA (US); Benjamin John KUS, Alameda, CA (US); Jonathan Shih-Shuo FAN, Oakland, CA (US)

Correspondence Address: GLENN PATENT GROUP, 3475 EDISON WAY, SUITE L, MENLO PARK, CA, 94025, US

(21) Appl. No.: 12/881,668

(22) Filed: Sep. 14, 2010

Related U.S. Application Data
(63) Continuation-in-part of application No. 12/044,614, filed on Mar. 7, 2008.
(60) Provisional application No. 60/893,528, filed on Mar. 7, 2007.
(60) Provisional application No. 61/242,278, filed on Sep. 14, 2009.

(51) Int. Cl. G06F 15/173

(52) U.S. Cl. 709/223

(57) ABSTRACT

Visibility and control are provided for a variety of different assets as found in a particular networked environment, such as, for example an enterprise network environment. Visibility and control of properties of assets are achieved by way of native agents, pseudo-agents that provide visibility and control of properties of assets of external systems by inspecting and applying changes into such assets, and bridges that provide visibility of other external data sources that cannot be controlled. A technique is provided that brings such visibility and control into a unified view that can be displayed in front of a console operator, for example. The controllable assets may be managed directly from the unified view at the console.

### CROSS REFERENCE TO RELATED APPLICATIONS

This application is a continuation-in-part of U.S. patent application Ser. No. 12/044,614, filed Mar. 7, 2008, which claims benefit of U.S. Provisional Application Ser. No. 60/893,528, filed Mar. 7, 2007, and this application claims benefit of U.S. Provisional Application Ser. No. 61/242,278, filed Sep. 14, 2009, each application of which is incorporated herein in its entirety by this reference thereto.

### BACKGROUND OF THE INVENTION

1. Technical Field

The invention relates to communications networks. More particularly, the invention relates to a technique for providing a unified view and management of an asset, offline, online, and virtual, in an extended relevance-based computing environment where policy engines run in many different distributed contexts and with scope across multiple devices.

2. Description of the Background Art

As information and computing technology continues to evolve and continues to become more pervasive among the general and global population, including enterprises, for example, managing and deploying such technology in any computing environment is challenging.

For example, an information technology (IT) administrator or organization may be responsible for managing many disparate devices, from a company laptop, computing nodes on a network, server farms, to desktop computers running different operating systems. In addition, there may be devices that the IT organization does not manage or cannot manage, which nevertheless impacts or influences IT decisions or enterprise policy decisions about the managed devices.

For example, some companies use external asset management systems that track where they purchased equipment, when they purchased it, how much the equipment cost, when the warranty expires. Such information is not available inside the computer, but is tracked externally.

Typically, IT administrators sift through thousands of pieces of information that relate to the services that are installed on various machines to calculate whether particular software, e.g. a virus scanner, is running on every device.

It would be desirable to provide a unified view and management of an asset, offline, online, and virtual, in an extended, relevance-based computing environment where policy engines run in many different distributed contexts and with scope across multiple devices.

### SUMMARY OF THE INVENTION

An embodiment of the invention provides visibility and control of a variety of different assets as found in a particular networked environment, such as, for example an enterprise network environment. An embodiment employs native agents to provide visibility and control of properties of assets; employs proxy-agents that can inspect and apply changes into such assets of external systems to provide visibility and control of properties of assets of external systems; employs bridges to provide visibility of other external data sources that cannot otherwise be controlled; and brings such visibility and control into a unified view that can be displayed in front of a console operator. An embodiment allows the controllable assets to be managed directly from the unified view at the console.

### BRIEF DESCRIPTION OF THE DRAWINGS

FIG. 1 is a block diagram showing an advisor viewpoint as described in U.S. Pat. No. 7, 277,919;

FIG. 2 is a block schematic diagram of a management system architecture which incorporates proxy-agents, in which a local office is shown, according to an embodiment;

FIG. 3 is a schematic diagram showing the relationship between a console display, assets, agents, and bridges according to an embodiment;

FIG. 4 is a sample display of a unified view of assets according to an embodiment; and

FIG. 5 is a block schematic diagram of a system in the exemplary form of a processor implemented computer system within which there is a set of instructions for causing the system to execute any one or more of the functions and/or steps of the embodiments of the invention disclosed herein.

### DETAILED DESCRIPTION OF THE INVENTION

An embodiment provides a policy engine that works well within the context with which it is managing. Also provided is a content model. Such are deployed within an enterprise to manage the devices on which they are deployed. In this way, deep penetration into manageable assets is achieved.

Unified view can be understood with reference to relevance based computing. Relevance based computing is disclosed, for example, in Donoho, D. et al, Relevance clause for computed relevance messaging, U.S. Pat. No. 7,277,919 (issued Oct. 2, 2007), which patent is incorporated herein in its entirety by this reference thereto. In such system “a collection of computers and associated communications infrastructure to offer a new communications process . . . allows information providers to broadcast information to a population of information consumers. The information may be targeted to those consumers who have a precisely formulated need for the information. This targeting may be based on information which is inaccessible to other communications protocols. The targeting also includes a time element. Information can be brought to the attention of the consumer precisely when it has become applicable, which may occur immediately upon receipt of the message, but may also occur long after the message arrives. The communications process may operate without intruding on consumers who do not exhibit the precisely-specified need for the information, and it may operate without compromising the security or privacy of the consumers who participate.” (Abstract)

One network architecture that embodies such system is the BigFix Enterprise Suite™ (BigFix, Inc, Emeryville, CA), which brings devices in such system under management by installing a native agent on each device. For platforms on which this is feasible, the use of native agents is considered to be the best method for monitoring and controlling devices. However, there are some platforms for which native agents are infeasible. For instance, network devices may be running proprietary OSs that are not designed to host third-party software. Other devices, such as service kiosks or mobile devices, may not have the resources available on the device itself to host a native agent. These platforms can typically be administered over some remotely accessible interface, and may in some cases be able to host limited third-party software.

An embodiment brings devices in a networked environment under the aegis of a distributed management system. In this embodiment, a device is either directly managed by a native agent, or indirectly managed by a proxy-agent. Key to an embodiment is a management system architecture that comprises a management console function and one or more agents in communication with the management console function either directly or indirectly and which perform a relevance determination function.

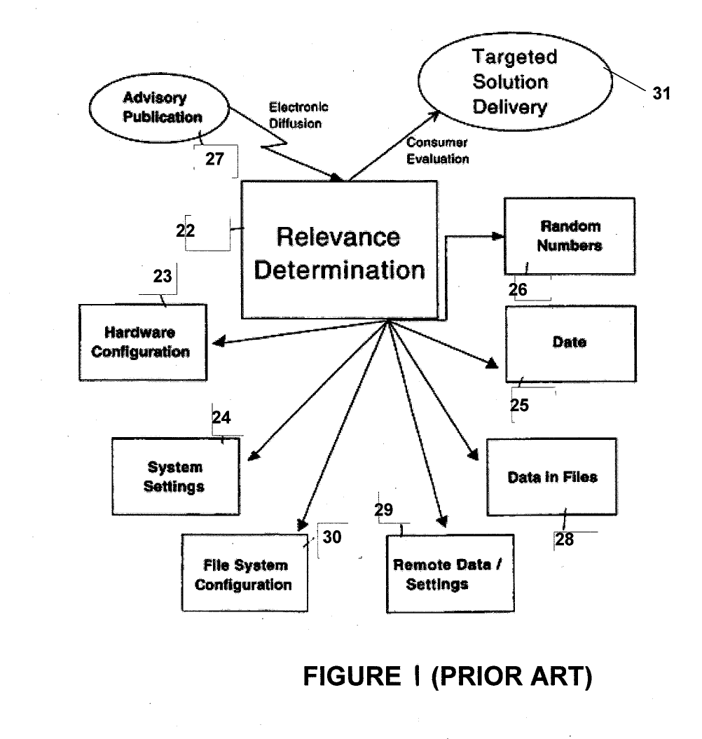

Relevance determination (see FIG. 1), for example, for targeted solution delivery 31, is carried out by an applications program, referred to as the advice reader 22 which, in the prior art (see U.S. Pat. No. 7,277,919) runs on a computer and may automatically evaluate relevance based on a potentially complex combination of conditions, including, but not limited to:
Hardware attributes. These are, for example, the type of computer on which the evaluation is performed, the type of hardware configuration 23, the capacity and uses of the hardware, the type of peripherals attached, and the attributes of peripherals.
Configuration attributes. These are, for example, values of settings for variables defined in the system configuration 30, the types of software applications installed, the version numbers and other attributes of the software, and other details of the software installation or system settings 24.
Database attributes. These are, for example, attributes of files 28 and databases on the computer where evaluation is performed, which may include existence, name, size, date of creation and modification, version, and contents.
Environmental attributes. These are, for example, attributes which can be determined after querying attached peripherals to learn the state of the environment in which the computer is located. Attributes may include results of thermal, acoustic, optical, geographic positioning, and other measuring devices.
Computed attributes. These are, for example, attributes which can be determined after appropriate computations based on knowledge of hardware, configuration, database, and environmental attributes, by applying specific mathematico-logical formulas or specific computational algorithms.
Remote attributes 29. These are, for example, hardware, configuration, database, environmental, and computed attributes that are available by communicating with other computers having an affinity for the user or his computer.
Timelines, e.g. Date 25. These are, for example, attributes based on the current time or a time which has elapsed since a key event, such as relevance evaluation or advice gathering.
Personal attributes. These are, for example, attributes about the human user(s) of the computer which can either be inferred by analysis of the hardware, the system configuration, the database attributes, the environmental attributes, or the remote attributes, or else can be obtained by soliciting the information directly from the user(s) or their agents.
Randomization 26. These are, for example, attributes resulting from the application of random and pseudo-random number generators.
Advice Attributes 27. These are, for example, attributes describing the configuration of the invention and the existence of certain advisories or types of advisories in the pool of advice.

In this way, whatever information is actually on the computer or reachable from the computer may in principle be used to determine relevance. The information accessible in this way can be quite general, ranging from personal data to professional work product to the state of specific hardware devices. As a result, an extremely broad range of assertions can be made the subject of relevance determination.

### Proxy-Agents

The invention herein extends this notion beyond a computer to devices or logical structures, such as proxy-agents (also referred to as pseudo-agents), that are physically or logically proximate to a computer. Proxy-agents are disclosed, for example, in co-assigned patent application to Lippincott, L. E., et al, Pseudo-Agents, U.S. patent application Ser. No. 12/044,614 (filed Mar. 7, 2008), which application is incorporated herein in its entirety by this reference thereto.

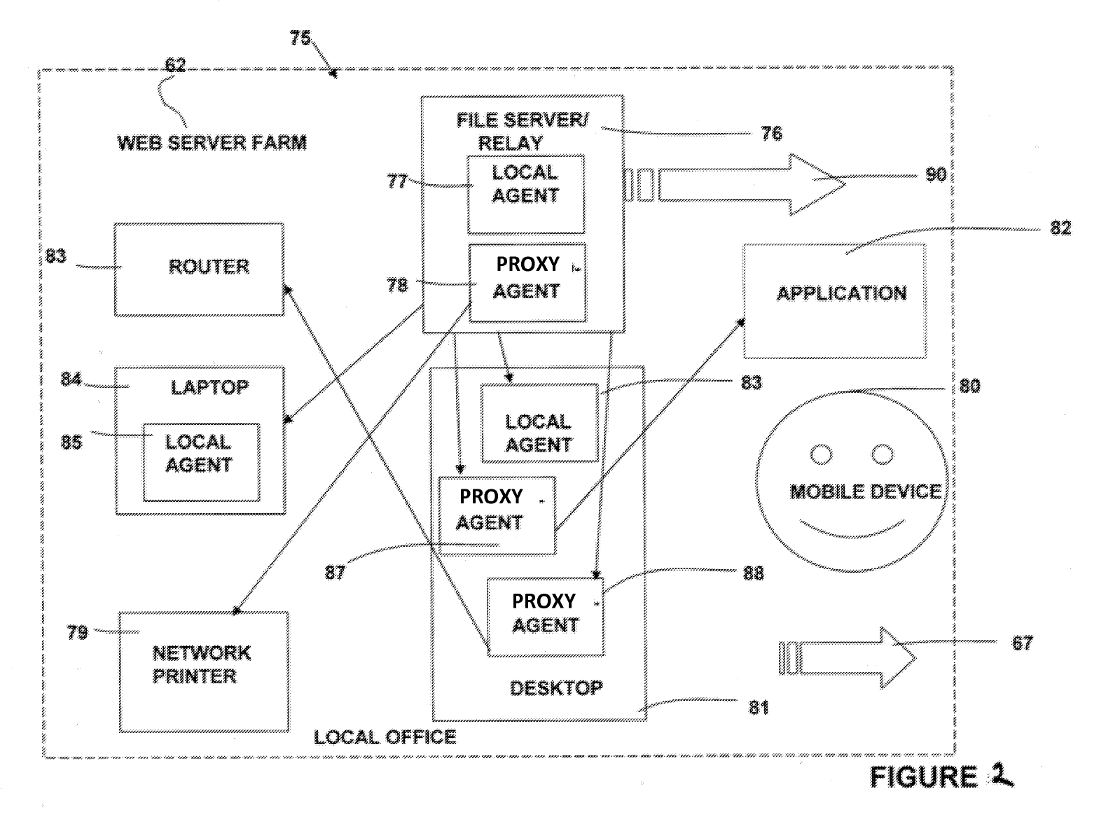

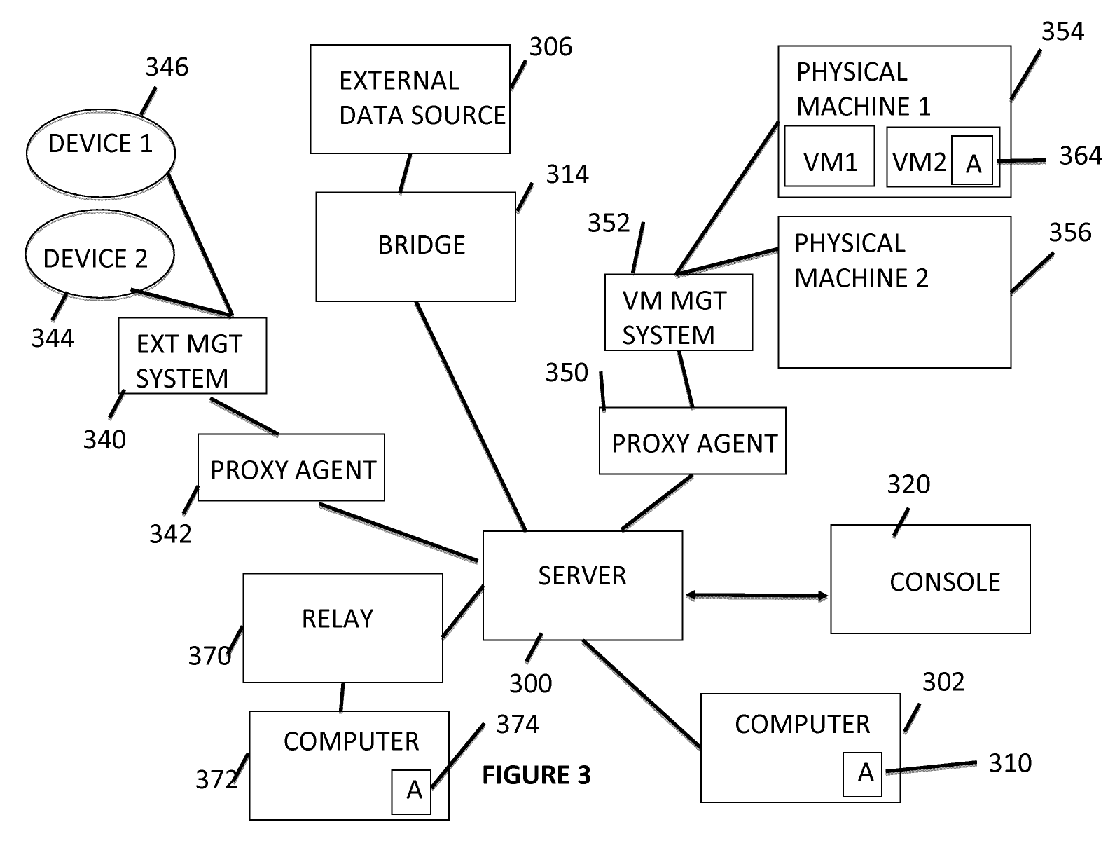

Proxy-agents can be understood by reference to FIG. 2. In the local office 75 there is a collection of real agents, for example in a file server/relay 76 (agent 77), a desktop computer 81 (agent 83), and a laptop computer 84 (agent 85). Proxy-agents 78, 87, and 88 are deployed to manage each of the different devices in the local office. In this example, there is a router 83 that has proxy-agent 88. There is proxy-agent 78 for a network printer 79 on the file server 76. A mobile device 80 resides most of its time in the local office, but its logical presence is over the cell network 67 and it is in touch with a mobile enterprise server back in the central office. Another important variant is a proxy-agent that indirectly manages a set of devices by way of one or more other management systems (see FIG. 3, discussed below). The Blackberry enterprise server is a management system that manages a collection of Blackberry devices. In this example, a proxy-agent manages the Blackberry devices by interacting with the Blackberry enterprise server.

An embodiment of the invention, discussed in further detail herein below, combines information from native and proxy-agents, and correlates this information with regard to one or more managed devices to create a unified view that provides greater manageability of such managed devices.

Managers can view and act on information

An embodiment provides a content evaluation model and content authoring model where new issues can be discovered and codified into messages. Those messages can flow to various policy engines that can then determine whether or not that condition applies to one or more assets. Managers, e.g. IT administrators, can then view that information and act on it.

### Unified View

It should be appreciated that an enterprise may own a wide variety of different devices and logical elements. For example, an IT department may be faced with not only a collection of devices upon which they can install agents, but also with a collection of devices upon which they can not install agent. An embodiment provides a console that delivers a unified view to an IT organization, such that IT managers can see not only the devices that can be directly managed, but also the devices that can not be directly managed. This technique gives context to the other devices.

An Example—IT department wanting to view a particular device to manage it in a network

Networking equipment may provide context for devices to perform their communications. Such devices have relationships to each other. They may be connected to each other. They may be two hops away from each other. Such devices have properties, such as addresses, hardware addresses, logical addresses, IP addresses, DNS names, and so forth. When the IT department is looking at a particular device to manage the device, the IT department can use such context to understand how the particular device fits into the network.

### An Example—Virtualization

An embodiment provides a unified view that includes virtualized machines and other such virtual systems. Virtualization allows for an abstraction between the operating system and the underlying physical hardware on which it is running, and it provides useful operations, such that one can move entire operating systems and all the applications that are running inside of them between hardware, as well as allow other operations that are typically not easy to perform.

There are certain properties of a virtual machine that are viewable and controllable by the virtual management system itself, such as the amount of resources that are allocated to that particular virtual machine. For example, one virtual machine might need a lot of computational resources and one can employ a standard virtual management system that manages virtual machines to set up and allocate resources to particular machines. For example, one virtual machine operating on the same physical host might be allocated eight processors, while another virtual machine operating on the same host might be only allocated one or two processors.

Such attributes are controlled external to the environment. An agent running inside that environment can not assign itself a different amount of resources. There are certain security reasons that virtual systems management vendors do not want agents that are running inside of those environments to be able to manipulate the resources that they are allowed to use.

Thus, it may be difficult to understand the context in which a particular machine is running. As well, a management system may have a virtual management infrastructure that is controlling externally visible and controllable parameters. As well, the management system may have some management agents running inside of those virtual machines that have better visibility into how particular software is operating inside of that environment and can see the world.

An embodiment is provided that correlates these two views and provides a unified view across both of those management infrastructures. Put another way, the unified view brings visibility of devices in the enterprise into a unified single pane of glass, such that an IT operations person can see the context in which the devices that he is managing are running and that allows him to correlate parameters from external management systems with native agents and proxy-agents own agent that might be running inside those virtual machines.

For example, a proxy-agent that runs external to a device can exercise API's that the device itself provides. This allows the proxy-agent to have visibility and some control over that context. Thus, the proxy-agent represents the device in a management system in a manner that is similar to that of a regular computing context that has a natural agent installed on it.

Correlation between Internal View and External View and Control

In an embodiment, a variety of other management systems are available within an enterprise that contain information about devices that can add context. Such information can comprise, for example, bridge data which associates physical devices, such as routers, with external information, such as warranty information; and proxy agent information, which shows host/guest relationships. For example, in a network an agent may not be able to compute, e.g. attributes of the routers through which it is communicating. However, management information about where the routers are located and how they are configured is available through the bridge. Information from the agent and from the bridge can be correlated to display a view for a user that shows the physical devices and/or the virtual machine devices, as well as the network context in which they are running relative to the routers.

Unified View Extracts Information from External Data Source

There are management systems that track informational data that is not available anywhere else. For example, many companies use asset management systems to track where they purchased equipment, when they purchased it, how much it cost, when the warranty expires, etc. Such information is not available inside the computer, but must be tracked externally. An embodiment extracts information from that external data source and makes it available in a unified view. Such view allows an IT operations person to look at a computer that he is about to service or is about to make a change to and notice such facts as the warranty is expired and the name of the vendor if it is necessary to troubleshoot an issue with the vendor.

### Bridge

A bridge is a software component that collects information from external data sources and forwards that information to a database. The bridge does not have a policy engine, it only collects attributes and flows them to the database on the server. An embodiment uses a bridge to import important properties from data sources that can provide context for the IT operator. For example, the IT operator may need to be aware of warranties, what vendor the software was purchased from, or from what vendor the hardware was purchased. The unified view sits atop all such different data sources and provides context for IT operations.

### An Embodiment Console

An embodiment provides visibility of aspects, i.e. a container, of a virtual machine and, as well, provides characteristics of the container that can be used to correlate with properties collected from an agent running inside the virtual machine, such that a unified view can be presented.

An embodiment provides importers that can hook up to external data sources, pull data from such external data sources into a common database, and make the data accessible for dashboards. A mechanism is contemplated that decides how and what information to display with the native information obtained from the agents themselves.

### Formalize and Generalize External Data Source

An embodiment contemplates formalizing the notion of an external data source such that it can be generalized. More structure is provided to detect the type of external data sources so that information can be collected from them. Such external data sources may include a database that contains warranty information or a software contracts database that contains a list of software titles and the machines on which they are allowed to be installed. As mentioned hereinabove, another example of an external data source is a virtual machine management system, such as the VMware management system (VMware, Inc.) that allows control of virtual machine external properties.

### Manageable Data Sources

An embodiment is configured to solve particular problems by allowing an organization to set up policies that control manageable data sources. For the purposes of discussion herein, a manageable data source is distinguished from a data source from which an entity may only extract information. VMware is an example of a manageable data source. A Blackberry Enterprise system (Research In Motion Limited) is another example of a data source that allows a collection of information to be pulled from every handheld device that is connected to the system and that allows certain management operations to issue from the system to the handheld devices. Thus, such system is a manageable infrastructure in the sense that instructions can be sent to that system and the system then carries out those instructions to apply change. Put another way, the two different kinds of data sources can be distinguished as those that are read only and those that are read/write.

### Content Model

An embodiment provides a content model that is designed to allow an expert to codify an issue into a message containing a relevance specification that defines how to detect that a certain condition exists, for that message to flow into the system that has the ability to detect the condition by evaluating the relevance specification, and then for the condition to be presented to the IT operations person.

For example, a best practices virtual machine management expert who has a particular expertise of configuring virtual machines and allocating the resources, can codify that expertise into a collection of content. Then, such advice is sent out to subscribers of that content. That content can then be evaluated within policy engines that have access to the virtual machine's characteristics. Thus, advice is delivered from this expert to those who need to consume that advice.

The advice might say, “Here's a machine that's heavily used. You should, therefore, allocate more CPUs to it.” Or, the advice might say, “This particular group of machines is experiencing problems, you should allocate more memory to them. Or you should deploy another physical device into this context and separate some of these virtual machines. There's just not enough computing power to support the applications that are running on there or the CPU consumption or the memory consumption that's taking place on those devices. ”

Thus, an embodiment builds a collection of advice around best practices and recommendations from an expert such that the advice can be consumed by consumers, such as an IT operations person, who may want to use the expert advice to configure these systems.

An embodiment provides a unified view that assists a user in maintaining systems as well as seeing whether such systems are in compliance with a certain set of standards.

### Pseudo Agent Technology and Policy Engine

An embodiment allows visibility and control, by way of the unified view, in managing a device on which an agent is not allowed to be installed or run. Another embodiment provides an extension that allows a management system to talk to another management system, extract information from it, have an evaluation context for a policy engine that can deliver advice about how that external system is set up, and then apply appropriate changes.

In this case, the policy engine connects to an external data source and collects attributes of a number of different objects, such as different virtual machines, PDA devices, or network routers. Information from these objects is pulled back into a context where content can be evaluated against those properties. Reports can be made to the enterprise's system and actions can be taken when the policy engine also hosts an action processor with which the management system can accept changes and be changed externally. The enterprise's system can flow policy changes back out into that external infrastructure.

### Unified View and Issues

An embodiment allows pulling together a variety of attributes of a system and incorporating them into a unified view. For example, an expert who is creating advice can look at every registry value or file or the set of applications that are installed or running to compute a very small footprint value that has to flow from that context up to the console where it can be displayed. The issue can be displayed and the set of machines that have that issue can be displayed to the console operator.

### Simplification

An embodiment can be understood with reference to FIG. 3. A server 300 is in communication with assets, such as computers 302, 372, devices 1 and 2 (346, 344), physical machines 1 and 2 (354, 356), and an external data source 306. In addition to a direct connection, the server communicates with these assets via such mechanisms a relay 370, a proxy-agent (342, 350, and a bridge 314. For example, a native agent 310 is installed on a computer 302, a proxy-agent 342 acts as liaison between the server 300 and an external management system 340, another proxy-agent 350 as acts a liaison between the server 300 and a virtual machine management system 352, and a bridge 314 sends informational data to the server 300 from an external data source 306. In the case of a proxy-agent, the proxy-agent 342 communicates with an external management system 340, such as a Blackberry enterprise management system, to control devices 344, 346, which may be Blackberry devices; while the proxy-agent 350 communicates with a virtual machine management system 352 to interact with physical machines 354, 356 and, in particular, with virtual machines VM1, VM2. In this example, virtual machine VM also has an agent 364. The console 320 provides a unified view to the user, and a common point of user interaction with the managed system.

It should be appreciated that the expert mentioned above regarding the content model makes recommendations that tell a user, such as an IT operations person, how to configure the systems or change the systems. The IT operations person is responsible for looking at that advice and deciding whether it applies or should not be applied. Over time, the IT operations person may become more and more trusting of the advice he is getting from his experts. In which case he may decide to stop looking quite so carefully at every piece of advice and just manage the systems according to the way that the advice is being proposed. Thus, a trust model builds between the expert and the person who is consuming the advice. Accordingly, an embodiment provides a system that conveys the advice and simplifies the process by which it is understood by the IT operator.

An embodiment provides a simplification mechanism in that the computers of the IT operator have already been measured against that set of advice and a corresponding report is displayed to him. For example, the report may say, “Your devices are configured in a particular way relative to what this external source says they should be or they can be.” An embodiment additionally can display a list of patches that may need to be applied, a list of services that need to be turned on, or a set of policies that need to be applied to effect changes to configuration of those machines. Thus, an embodiment displays a list of issues and suggestions that the author of that content is providing that contain changes that could be applied. And then that list is read. Displaying the list is convenient because, when there are no machines in the environment that are out of compliance with what the content author is proposing, the IT operator does not see the message, or it appears with a counter indicating the number of contexts in which the condition is detected and this number may be zero.

An embodiment is also provided that only displays a set of the differences between the way the systems are configured and the way that they are supposed to be configured.

### Content Model-Advice

An embodiment provides a model that allows the IT operator, instead of sifting through thousands of pieces of information concerning what services are installed to calculate whether a particular virus scanner is running on every device or not, to turn that upside down and contemplate what it means to have a virus scanner installed a particular machine. The IT operator can then create content that measures this aspect of the system. Then the IT operator is notified when such virus scanners are not set up right in a variety of different ways. IN this way, the IT operator is not inundated with information. Instead, the system propagates advice that is proposed as a set of changes.

### Visibility: Drill Down Capability

An embodiment provides another kind of content that collects an interesting set of properties from a particular machine that can be quite useful in its own right.

For example, when an IT operator knows the virus scanner is running, he might want to know what particular virus scanner is running on which machine. He might want to have a breakdown of two-thirds of the machines that are running a first virus scanner and one-third that are running that another virus scanner. Thus, those kinds of charts, statistics, and displays can be calculated by deploying an analysis created by a content author that identifies an interesting set of properties which the IT operator might want to collect from his machines. Using the management console, the IT operator can authorize the set of properties to be measured, monitored, and the values communicated to the server by sending an analysis activation policy to the agents or proxy-agents. i.e. to the policy engines running in the machine or external to the machine, instructing collection of those attributes from the machine and flowing them back into the management system, such that a dashboard can be presented that shows the breakdown of those properties. In addition to a statistical summary, enough information is present such that he can even drill down to find out for a particular machine, what particular virus scanner is running on it and when it was updated.

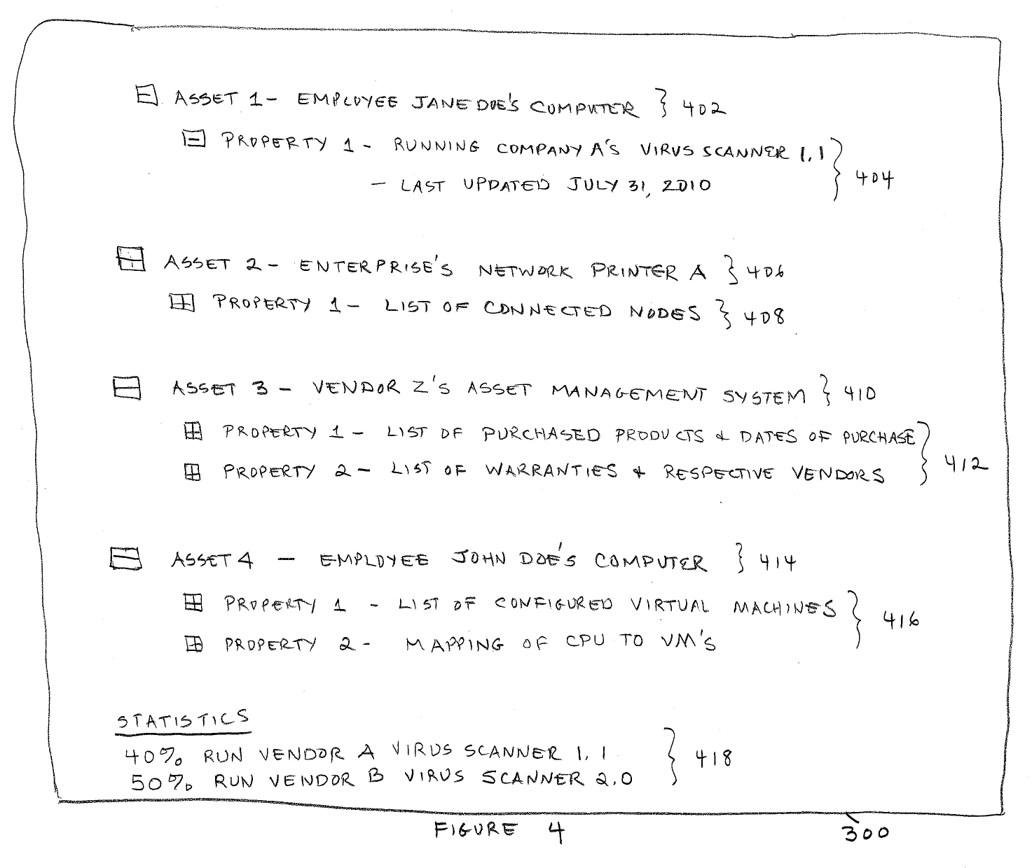

An embodiment of visibility and control, including drill down capability, can be understood with reference to FIG. 4. FIG. 4 shows a sample of a UI view of disparate assets. It should be appreciated that FIG. 4 is by way of example only and is not meant to be limiting. Asset 1 (402) is a graphic that represents Employee Jane Doe's computer. The graphic can be opened up for displaying its properties. Thus, one can drill down to see more information about Jane Doe's computer. For example, property 1 (404) is shown as opened up. An IT administrator, for example, can glean from property 1 that Jane Doe's computer is running Company A′s virus scanner 1.1 and that the computer was last updated on July 31, 2010. Similarly, Asset 2 (406), Asset 3 (410), and Asset 4 (414) are displayed on console 300, because they are members of the environment. Property 1 for Asset 2 (408), a network printer, when selected to be opened up, shows a list of connected nodes. Property 1 and Property 2 (collectively, 412) indicate that lists of purchased products and dates of purchase and of warranties and their vendors, respectively. Property 1 and Property 2 (collectively, 416) indicate that John Doe's computer has at least one virtual machine running on it and that one can view the mapping of computer processing usage (CPU) to each of the virtual machines. Console 300 also displays statistics. For example, console 300 shows that 40 percent of the assets are running Vendor A′s virus scanner version 1.1 and 50 percent of the assets are running Vendor B′s virus scanner version 2.0.

It should be appreciated that in an embodiment, such mechanism uses a relevance engine and inspectors, as discussed hereinabove. As well, both the

Boolean calculations of what is relevant, as well as the set of properties, may be pulled back from the machine. That is, the inspectors get visibility into aspects of the machine. The relevance language allows combining those aspects into Booleans that can simplify the display of the results.

### Content Type-Action

An embodiment provides another kind of content type that is referred to as an action for control. An action flows through a system out to machines. The machines, i.e. the policy engines running in those machines, look at that action and decide whether or not it applies to the machine.

An embodiment contemplates targeting actions by an ID associated with the object or based on an attribute of the object, e.g. all desktop machines might be the target. The action might have additional targeting that knows a machine may have a particular application installed or that particular registry key set or that a particular file exists in the file system and its version number, when some property of it matches some criteria.

In an embodiment, actions can contain instructions or a list of instructions to perform. For example, the policy engine may authenticate that the action assigned by an IT operator who is allowed to manage that device, and then it evaluates the targeting to decide whether or not this particular device or within a set of objects, to what set of objects this action should be applied. Remediation language is built into the policy engine that consists of instructions, e.g. for downloading files, verifying authenticity, moving files around, touching the registry, manipulating files, executing programs, restarting the machine, and interacting with an end-user to ask them a question, etc.

Remediation actions are available. Native capabilities are built into the platform that allow actions to be orchestrated. In the meantime, the actions themselves have attributes that are changing with time such that when an action is relevant on a particular machine such as waiting for a download, then when the download completes, it might be waiting for a change control window or it might be waiting for an end user to enter an input. Thus, the action is running and proceeding through its various steps. In an embodiment, each one of these states of an action is reported because these are properties of the machine and can be reported and displayed in the unified view.

### Feedback to Console Operator

In an embodiment, user experience in the console provides feedback to the console operator about the progress of his action, the set of machines for which the action is being applied, and the state in which each one of those machines is in with regard to the action. Thus, an embodiment provides high granularity of feedback in response to deploying an action. This provides control by creating actions that deliver the control.

### Content Model: Domain Specific View

An embodiment is provided that incorporates a domain specific view, as described in co-assigned and co-pending patent application entitled, “Policy and relevance-based UI”. A view is dynamically built that is associated with a particular domain and that flows from the content authors as well. Such domain specific view allows presenting a single pane of glass that allows an IT operator to make decisions. For example, the IT operator, upon looking at the view, can identify his patch status and look at a view that is presented in the lexicon of patching. A single pane of glass is provided, but presents different domain level views that apply to particular problem sets and particular kinds of problems that an IT operator is trying to address.

### AN EXEMPLARY MACHINE OVERVIEW

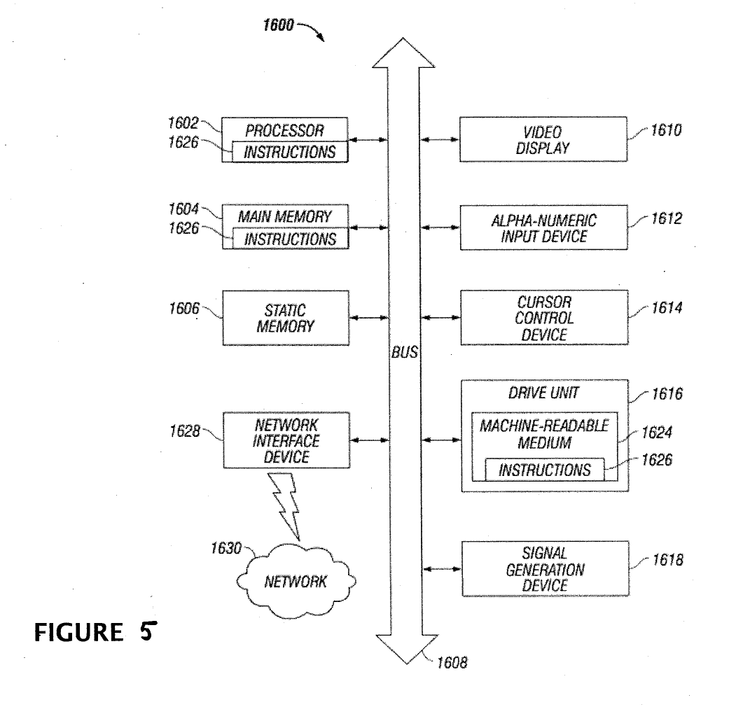

FIG. 5 is a block schematic diagram of a system in the exemplary form of a computer system 1600 within which a set of instructions for causing the system to perform any one of the foregoing methodologies may be executed. In alternative embodiments, the system may comprise a network router, a network switch, a network bridge, personal digital assistant (PDA), a cellular telephone, a Web appliance or any system capable of executing a sequence of instructions that specify actions to be taken by that system.

The computer system 1600 includes a processor 1602, a main memory 1604 and a static memory 1606, which communicate with each other via a bus 1608. The computer system 1600 may further include a display unit 1610, for example, a liquid crystal display (LCD) or a cathode ray tube (CRT). The computer system 1600 also includes an alphanumeric input device 1612, for example, a keyboard;

a cursor control device 1614, for example, a mouse; a disk drive unit 1616, a signal generation device 1618, for example, a speaker, and a network interface device 1620.

The disk drive unit 1616 includes a machine-readable medium 1624 on which is stored a set of executable instructions, i.e. software, 1626 embodying any one, or all, of the methodologies described herein below. The software 1626 is also shown to reside, completely or at least partially, within the main memory 1604 and/or within the processor 1602. The software 1626 may further be transmitted or received over a network 1628, 1630 by means of a network interface device 1620.

In contrast to the system 1600 discussed above, a different embodiment uses logic circuitry instead of computer-executed instructions to implement processing entities. Depending upon the particular requirements of the application in the areas of speed, expense, tooling costs, and the like, this logic may be implemented by constructing an application-specific integrated circuit (ASIC) having thousands of tiny integrated transistors. Such an ASIC may be implemented with CMOS (complimentary metal oxide semiconductor), TTL (transistor-transistor logic), VLSI (very large systems integration), or another suitable construction. Other alternatives include a digital signal processing chip (DSP), discrete circuitry (such as resistors, capacitors, diodes, inductors, and transistors), field programmable gate array (FPGA), programmable logic array (PLA), programmable logic device (PLD), and the like.

It is to be understood that embodiments may be used as or to support software programs or software modules executed upon some form of processing core (such as the CPU of a computer) or otherwise implemented or realized upon or within a system or computer readable medium. A machine-readable medium includes any mechanism for storing or transmitting information in a form readable by a machine, e.g. a computer. For example, a machine readable medium includes read-only memory (ROM); random access memory (RAM); magnetic disk storage media; optical storage media; flash memory devices; electrical, optical, acoustical or other form of propagated signals, for example, carrier waves, infrared signals, digital signals, etc.; or any other type of media suitable for storing or transmitting information.

Although the invention is described herein with reference to the preferred embodiment, one skilled in the art will readily appreciate that other applications may be substituted for those set forth herein without departing from the spirit and scope of the present invention. Accordingly, the invention should only be limited by the Claims included below.

1. An apparatus for presenting a unified view for management of a plurality of devices and logical elements in a distributed network, comprising:
at least one agent that is any of hosted on, logically proximate to, and physically proximate to said devices and logical elements, said agent configured for allowing visibility and control over said devices and logical elements;
at least one bridge that is physically proximate to at least one external data system, said bridge configured to provide visibility of but no control over said external data system;
a management system configured for receiving information from said devices and logical elements and from said bridge, and for propagating advice to any of said devices and logical elements, based on any of an automatic response and a human response caused by a particular representation of said devices and logical elements, and said external data system, wherein said propagated advice comprises an action which causes relevant ones of said devices and logical elements to change, and wherein said change is caused by said at least one agent; and
a console configured for presenting correlated information from both one or more of said devices and logical elements, and from said external data systems in a unified view of any of said devices, logical elements, and external data systems.

2. The apparatus of claim 1, wherein said at least one agent and said at least one bridge are configured to inspect said devices and logical elements, and said external data system, and to obtain associated properties and send said properties to said management system for display on said console; and
wherein said console is configured to provide drill down capability that allows particular properties of a particular device, logical element, or external data system to be viewed.

3. The apparatus of claim 1, wherein said management system is configured for providing collaborative statistics on properties of said at least one device and logical element; and for causing said console to present said collaborative statistics to a user.

4. The apparatus of claim 1, wherein at least one of said logical elements comprises a virtual machine that is associated with at least one of said devices.

5. The apparatus of claim 1, wherein said at least one agent is configured for detecting an issue with any of said devices or logical elements, and for notifying said management system about said issue, wherein said management system is configured for causing said console to display a content message that identifies said issue for further action.

6. The apparatus of claim 1, wherein said at least one agent is configured for determining relevance of said propagated advice, wherein if said at least one agent determines that said propagated advice is not relevant, said at least one agent does not apply said propagated advice.

7. The apparatus of claim 1, wherein said management system is further configured to propagate advice by precise targeting, wherein said precise targeting is by device ID or based on particular attributes of said devices or logical elements.

8. The apparatus of claim 1, wherein said action has attributes that change state over time, and wherein each one of said states is reported to said management system for display on said console .

9. The apparatus of claim 4, wherein said console is configured to present a mapping of virtual machines to devices and a mapping of computational resources to virtual machines; and wherein said console is configured to allow creating and removing of virtual machines on a device and to allow reallocating computational resources among virtual machines on a particular device.

10. A computer implemented method for presenting a unified view for management of a plurality of devices and logical elements in a distributed network, comprising the steps of:
providing at least one agent that is any of hosted on, logically proximate to, and physically proximate to said devices and logical elements, said agent configured for allowing visibility and control over said devices and logical elements;
providing at least one bridge that is physically proximate to at least one external data system, said bridge configured to provide visibility of but no control over said external data system;
providing a management system configured for receiving information from said devices and logical elements and from said bridge, and for propagating advice to any of said devices and logical elements, based on any of an automatic response and a human response caused by a particular representation of said devices and logical elements, and said external data system, wherein said propagated advice comprises an action which causes relevant ones of said devices and logical elements to change, and wherein said change is caused by said at least one agent; and
providing a console configured for presenting correlated information from both one or more of said devices and logical elements, and from said external data systems in a unified view of any of said devices, logical elements, and external data systems.

11. An apparatus for presenting a unified view and management of a plurality of devices and logical elements in a distributed network, comprising:
at least one agent that is any of hosted on, logically proximate to, and physically proximate to said devices and logical elements, said agent configured for allowing visibility and control over said devices and logical elements;
at least one bridge that is physically proximate to at least one external data system, said bridge configured to provide visibility of but no control over said external data system;
a management system configured for receiving information from said devices and logical elements and from said bridge; and
a console configured for presenting correlated information from both one or more of said devices and logical elements, and from said external data systems in a unified view of any of said devices, logical elements, and external data systems and for effecting control of said one or more of said devices and logical elements.

12. An apparatus for presenting a unified view for management of a plurality of devices and logical elements in a distributed network, comprising:
at least one agent that is any of hosted on, logically proximate to, and physically proximate to said devices and logical elements, said agent configured for allowing visibility and control over said devices and logical elements;
a management system configured for receiving information from said devices and logical elements and, if present, from at least one bridge that is physically proximate to at least one external data system, said bridge configured to provide visibility of but no control over said external data system, and for propagating advice to any of said devices and logical elements, based on any of an automatic response and a human response caused by a particular representation of said devices and logical elements, and said external data system, wherein said propagated advice comprises an action which causes relevant ones of said devices and logical elements to change, and wherein said change is caused by said at least one agent; and
a console configured for presenting correlated information from both one or more of said devices and logical elements, and from said external data systems in a unified view of any of said devices, logical elements, and external data systems.
